(19) United States
(12) Patent Application Publication
(10) Pub. No.: US 2008/0247459 A1
(43) Pub. Date: Oct. 9, 2008

(54) Method and System for Providing Content Adaptive Binary Arithmetic Coder Output Bit Counting

(75) Inventor: Yendo Hu, La Jolla, CA (US)

Correspondence Address: Motorola, Inc.;Law Department, 1303 East Algonquin Road, 3rd Floor, Schaumburg, IL, 60196, US

(73) Assignee: General Instrument Corporation, Horsham, PA (US)

(21) Appl. No.: 11/696,563

(22) Filed: Apr. 4, 2007

(51) Int. Cl. H04N 11/02

(52) U.S. Cl. 375/240.02

(57) ABSTRACT

A process may be utilized for encoding MBs. The process records a plurality of CABAC weight values for a first MB. The first MB resides in a first edge of a first frame in a plurality of images. Further, the process encodes the first MB with the plurality of CABAC weight values. In addition, the process initializes a second frame in the plurality of the images with the plurality of CABAC weight values. Finally, the process encodes a second MB with the plurality of CABAC weight values. The second MB resides in a second edge of a second frame in the plurality of images.

### BACKGROUND

1. Field

This disclosure generally relates to the field of video data processing. More particularly, the disclosure relates to Context Adaptive Binary Arithmetic Coding (“CABAC”) for digital video encoders.

2. General Background

Video signals generally include data corresponding to one or more video frames. Each video frame is composed of an array of picture elements, which are called pixels. A typical color video frame having a standard resolution may be composed of over several hundreds of thousands of pixels, which are arranged in arrays of blocks. Each pixel is characterized by pixel data indicative of a hue (predominant color), saturation (color intensity), and luminance (color brightness) The hue and saturation characteristics may be referred to as the chrominance. Accordingly, the pixel data includes chrominance and luminance. Therefore, the pixel data may be represented by groups of four luminance pixel blocks and two chrominance pixel blocks These groups are called macroblocks (“MBs”3) As a video frame generally includes many pixels, the video frame also includes a large number of MBs. Thus, digital signals representing a sequence of video frame data, which usually include many video frames, have a large number of bits. However, the available storage space and bandwidth for transmitting these digital signals is limited. Therefore, compression processes are used to more efficiently transmit or store video data

Compression of digital video signals for transmission or for storage has become widely practiced in a variety of contexts. For example, multimedia environments for video conferencing, video games, Internet image transmissions, digital TV, and the like utilize compression Coding and decoding are accomplished with coding processors. Examples of such coding processors include general computers, special hardware, multimedia boards, or other suitable processing devices. Further, the coding processors may utilize one of a variety of coding techniques, such as variable length coding (“VLC”), fixed coding, Huffman coding, blocks of symbols coding, and arithmetic coding. An example of arithmetic coding is Context Adaptive Binary Arithmetic Coding (“CABAC”).

CABAC techniques are capable of losslessly compressing syntax elements in a video stream using the probabilities of syntax elements in a given context. The CABAC process will take in syntax elements representing all elements within a macroblock. Further, the CABAC process constructs a compress bit sequence by building out the following structure: the sequential set of fields for the macroblock based on the chosen macroblock configuration, the specific syntax element type and value for each of the fields within this field sequence, and the context address for each of the syntax elements. The CABAC process will then perform binarization of the syntax elements, update the context weights, arithmetically encode the binarizations of syntax elements (“bins”), and subsequently pack the bits into bytes through the syntax element processing component.

The components of the CABAC process include: the CABAC weight initialization mode selection module, the macroblock syntax sequence generator, the binarization engine, the context address generator, the context weight update engine, the arithmetic coder, the bit packetizer, and the Network Abstraction Layer (“NAL”) header generator. The CABAC engine within a video encoder may accomplish two goals within the encoding process: (1) to carry out compressed data resource prediction for mode decision purposes; and (2) to losslessly compress the data for signal output delivery. The compressed data resource prediction task predicts the amount of bits required given a set of specific encoding modes for a given macroblock. Potential mode decision implementations may have up to eight modes to select from. The computational demand on the CABAC engine to support the mode decision task is significant.

Within an MPEG4 video encoder, the CABAC engine carries out compressed data resource prediction and delivers the actual compressed data sequence. The compressed data resource prediction engine predicts the amount of bits required given a set of specific mode decision for a given MB.

The computational demand for the CABAC process is demanding when implemented on a sequential processing machine. Thus, implementations typically compromise on mode decision CABAC resource estimation accuracy by limiting the CABAC to binarization level accuracy.

### SUMMARY

In one aspect of the disclosure, a process may be utilized for encoding MBs. The process records a plurality of CABAC weight values for a first MB. The first MB resides in a first edge of a first frame in a plurality of images. Further, the process encodes the first MB with the plurality of CABAC weight values. In addition, the process initializes a second frame in the plurality of the images with the plurality of CABAC weight values. Finally, the process encodes a second MB with the plurality of CABAC weight values. The second MB resides in a second edge of a second frame in the plurality of images.

In another aspect of the disclosure, a process may be utilized for encoding an MB. The process selects a plurality of CABAC weight values from a set of predefined CABAC weight values. Further, the process initializes a frame in a plurality of images with the plurality of CABAC weight values. Finally, the process encodes an MB with the plurality of CABAC weight values. The MB resides in an edge of the frame in the plurality of images.

In yet another aspect of the disclosure, a process may be utilized for encoding MBs. The process records a plurality of CABAC weight values for a first MB. The first MB resides in a first edge of a first frame in a plurality of images. Further, the process encodes, with a full frame bit CABAC encoder, the first MB with the plurality of CABAC weight values. In addition, the process initializes a second frame in the plurality of the images with the plurality of CABAC weight values. Finally, the process encodes, with a bit counting CABAC encoders a second MB with the plurality of CABAC weight values. The second MB resides in a second edge of a second frame in the plurality of images.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a CABAC process

FIG. 2 illustrates a modified CABAC process.

FIGS. 3A-3D illustrates how the CABAC Weight Initialization Engine processes data.

FIG. 4 illustrates a context memory management engine utilizing minimum cycle time.

FIG. 5 illustrates an external store context management architecture utilizing minimum logic hardware.

FIG. 6 illustrates a process that may be utilized for encoding MBs.

FIG. 7 illustrates another process that may be utilized for encoding an MB.

FIG. 8 illustrates yet another process that may be utilized for encoding MBs.

FIG. 9 illustrates a block diagram of a station or system that implements content adaptive binary arithmetic coder output bit counting.

### DETAILED DESCRIPTION

A method and system are disclosed, which provide an improved video digital data compression capable of providing a single cycle normalization for real-time digital video encoders, such as an MPEG-4 or an H-264 series encoder. The method and system may be utilized by the back end processor within the arithmetic encoder. As a result, normalization and payload to byte packing may be accomplished. Accordingly, a mode selection engine can carry out the complete CABAC process over multiple MB modes, which improves MPEG4 compression performance. Further, the mode selection engine is a cost effective approach that is capable of off loading work from a Digital Signal Process (“DSP”) and determining the exact number of compressed output bits for each MB compression choice. In addition, the mode selection engine covers worst case conditions, such as the syntax element size potentially increasing significantly, e.g., potentially over eight fold when encoding I frames

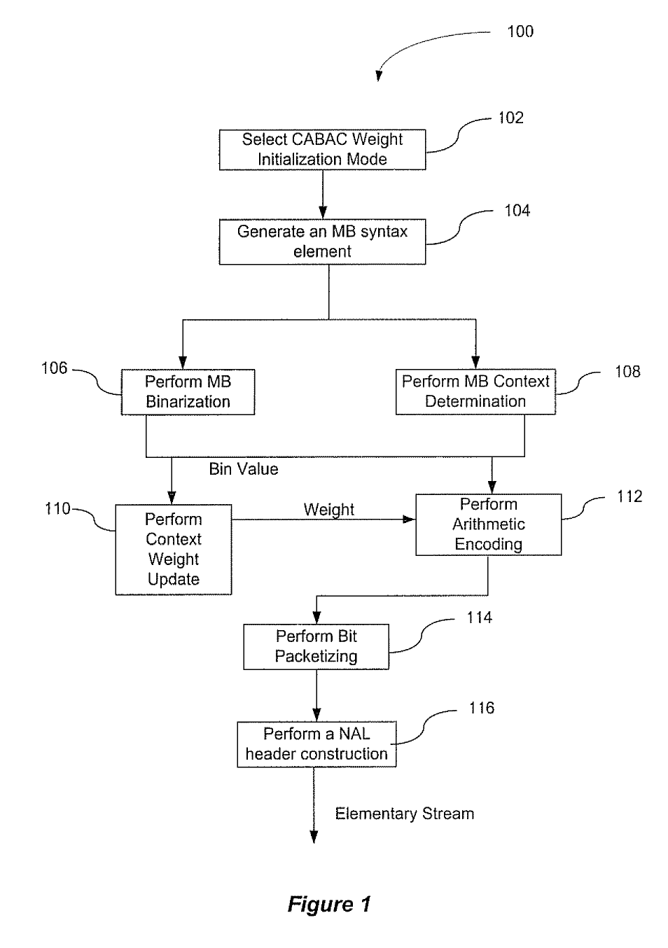

FIG. 1 illustrates a CABAC process 100. At a process block 102, the CABAC process 100 selects a CABAC weight initialization mode. Further, at a process block 104, the CABAC process 100 generates an MB syntax sequence. In addition, at a process block 106, the CABAC process 106 converts a syntax to binary. The term binarization may be utilized to denote the process block 106. Further, at a process block 108, the CABAC process 100 performs a context address determination. The term ctxldx generation may be utilized to denote the process block 108. At a process block 110, the CABAC process 100 performs a context weight update. Further, at a process block 112, the CABAC process 100 performs an arithmetic encoding. In addition, at a process block 114, the CABAC process 100 performs a bit packetizing Finally, at a process block 116, the CABAC process 100 performs a NAL header construction. An elementary stream results from the CABAC process 100.

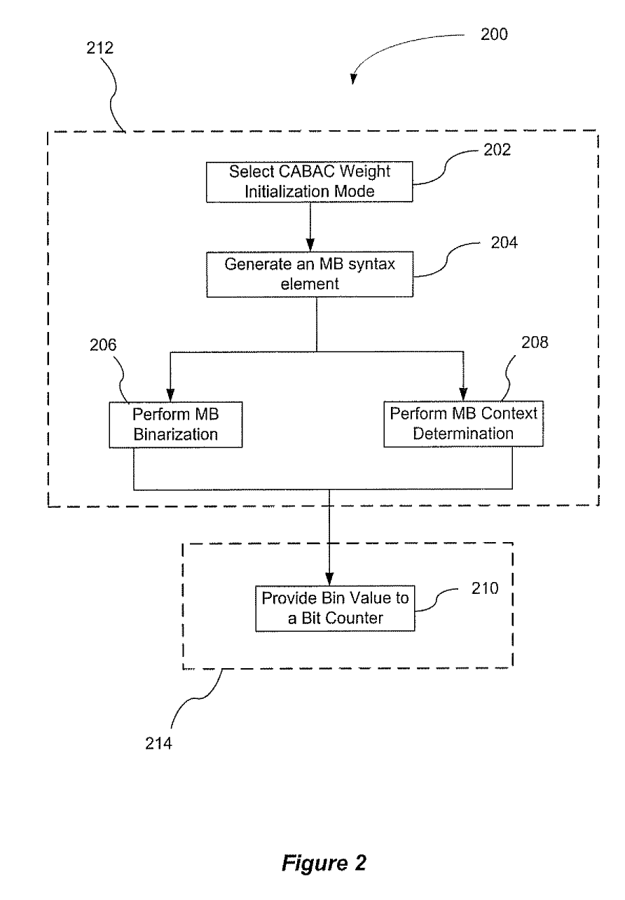

FIG. 2 illustrates a modified CABAC process 200. At a process block 202, the modified CABAC process 200 selects a CABAC weight initialization mode. Further, the process 200 may determine a plurality of new weight values. In addition, at a process block 204, the modified CABAC process 200 generates an MB syntax sequence. In one embodiment, the MB syntax sequence is based on the plurality of new weight values. The MB syntax sequence may include a syntax type and a syntax value. At a process block 206, the modified CABAC process 200 converts a syntax to binary. Further, at a process block 208, the modified CABAC process 200 performs a context address determination. Finally, at a process block 210, the modified CABAC process 200 provides a binarization value to a bit counter.

The process blocks 202 through 208 may be implemented in a resource estimation engine 212, which resides in the mode selection engine. In one embodiment, the resource estimation engine 212 resides in the same physical location as the mode selection engine. In an alternative embodiment, the resource estimation engine 212 resides in a distinct location from the mode selection engine. Further, the process block 210 may be implemented in a final stream construction engine 214, which constructs the final compressed bit sequence. In addition, the final stream construction engine is independent from the mode selection engine. In one embodiment, the process block 210 has a bit counter function. The bit counter function includes a bit counter, weight initialization engine, and the weight management engine. Algorithms and techniques are provided to properly estimate the initial weights and the weight management functions for a scenario in which multiple encodings of different modes of the same MB are utilized.

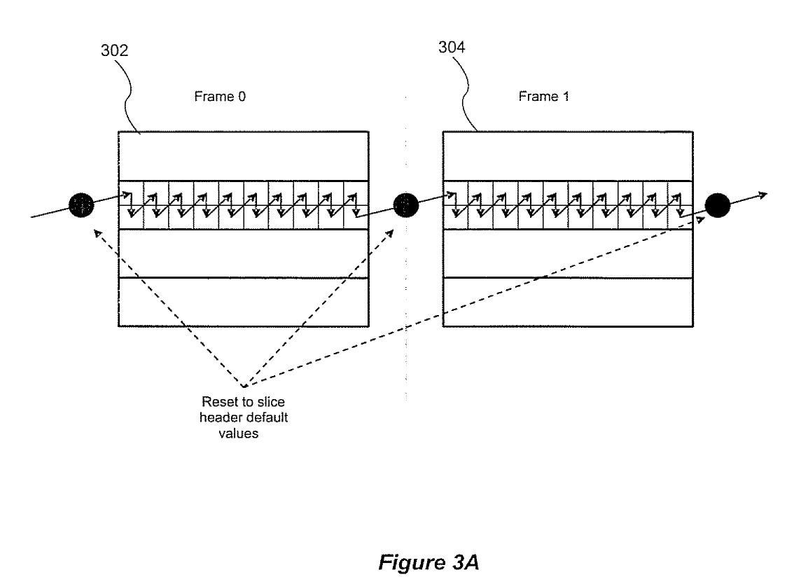

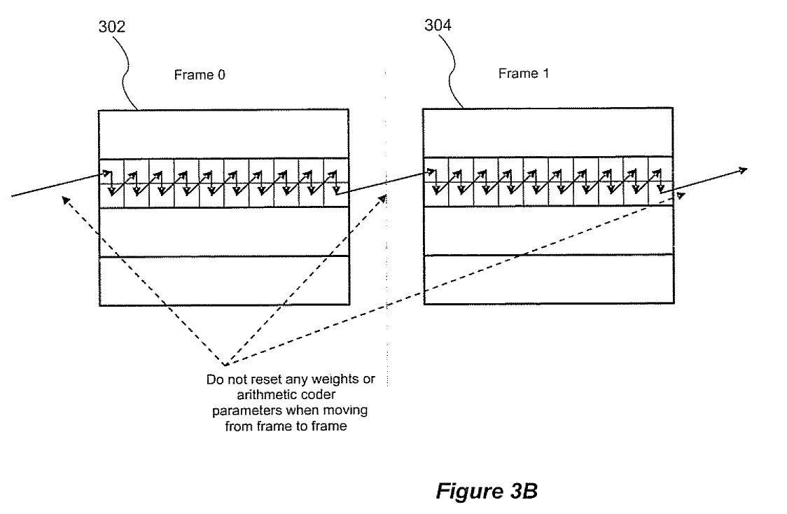

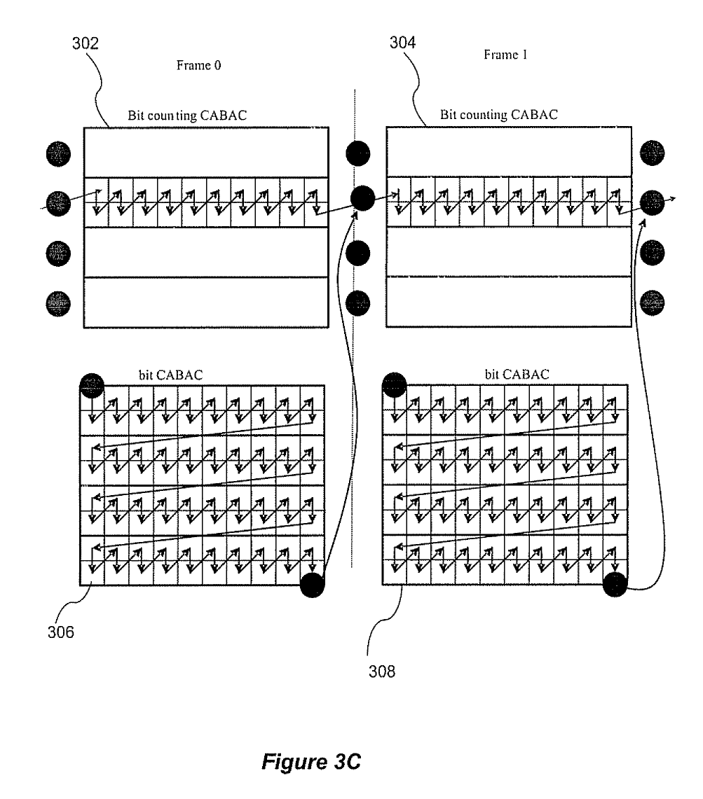

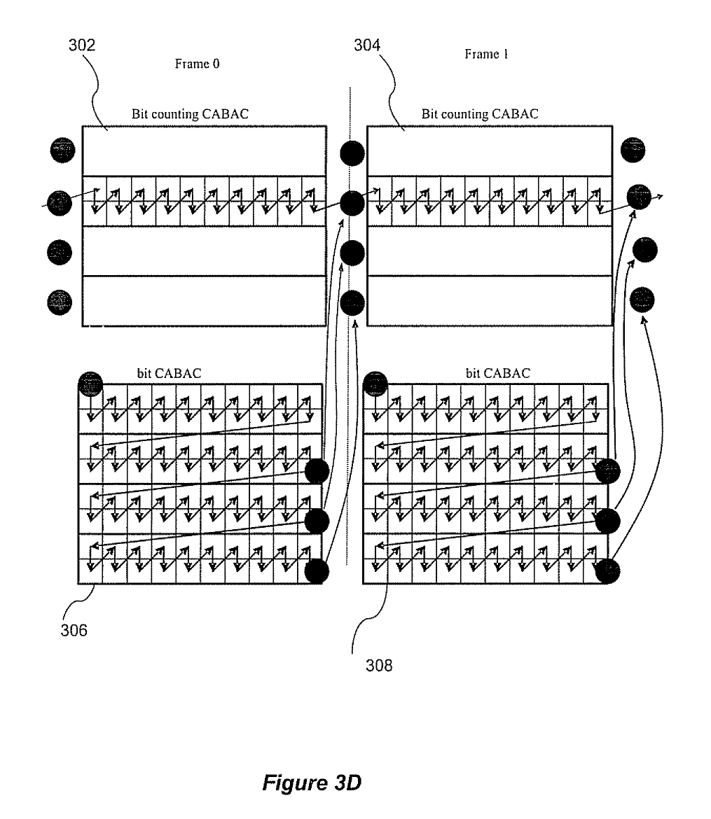

FIGS. 3A-3D illustrates how the CABAC Weight Initialization Engine processes data. In a sliced based architecture where multiple engines process the frame through horizontal rows, the resource estimation engine 212 in the mode selection engine will not have the actual weights because the slices will simultaneously start the modified CABAC process 200 of each respective slice's own MB pair. However, CABAC processing adjusts the context weights dynamically in a raster scan fashion through each MB row. The slice processing engines will not have accurate context weights until the previous slice engine completely finishes compressing its row of MBs. Accordingly, the context weights for the encoder may be initialized at the beginning of each frame.

FIG. 3A illustrates an approach in which the slice engine resets CABAC weights/parameters to the default slice header values, as defined in MPEG4, at the beginning of each panel. In one embodiment, the panel is a horizontal section of the video image. Accordingly, the CABAC weights/parameters are reset to the default slice header values in bit counting CABAC encoders for a sequence of panels, e.g., a bit counting CABAC encoder numbered zero 302 for a frame zero and a bit counting CABAC encoder 304 numbered one for a frame numbered one.

FIG. 3B illustrates an approach in which the slice engine does not reset the CABAC weights/parameters as the slice engine moves from frame to frame. For example, the CABAC weights/parameters are not reset to the default slice header values in bit counting CABAC encoders for a sequence of panels, e.g., a bit counting CABAC encoder numbered zero 302 for a frame zero and a bit counting CABAC encoder 304 numbered one for a frame numbered one. In one embodiment, the simulator keeps track of a plurality of weight/parameter sets equal to the number of panels in each video image. For instance, the simulator may effectively keep track of twenty three independent weight/parameter sets, one for each of the panels within the same video image. For example, FIG. 3B shows an image with four panels.

FIG. 3C illustrates an approach in which the slice engine resets the CABAC weights/parameters utilizing the resulting weights from the final bit generator, as opposed to the bit counter, when the slice engine finishes the previous frame. Accordingly, the CABAC weights/parameters are reset to the default slice header values in bit counting CABAC encoders for a sequence of frames after the slice engine finishes a bit CABAC for a previous frame. For instance, the slice engine finishes a bit CABAC 306 for the bit counting CABAC encoder numbered zero 302 for the frame zero and then resets the CABAC weights/parameters of the bit counting CABAC encoder numbered one 304 of the first frame to the default slice header values. The slice engine then proceeds to a bit CABAC 308 in a similar fashion.

FIG. 3D illustrates an approach in which the slice engine resets the bit counting CABAC weights/parameters from the bit CABAC engine at the same relative position. For instance, the slice engine finishes the second row of a bit CABAC 306 for the bit counting CASBAC number zero 302 for the frame zero and then resets the CABAC weights/parameters of the second row of the bit counting CABAC encoder numbered one 304 of the first frame to the default slice header values. The slice engine then proceeds to the bit CABAC 308 in a similar fashion.

A weight management engine may be utilized along with the weight initialization engine and a bit counter to implement the bit counter function and the associated algorithms presented in FIGS. 3A-3D. In one embodiment, a CABAC engine may work on up to eight macro block modes for a common starting reference context table state. At the end of each mode selection phase, the CABAC engine updates the common context table reference state to reflect the selected mode for the next macro block mode analysis phase. In one embodiment, the context tables are stored for all mode states within internal memory for future updating based on the selected mode decision from the external processor. This approach provides internal memory to expedite processing time. In another embodiment, only the current tables and the reference context tables are maintained through the mode analysis phase. The external processor resends the selected mode syntax elements in order to update the reference context table for the next macro block mode analysis phase.

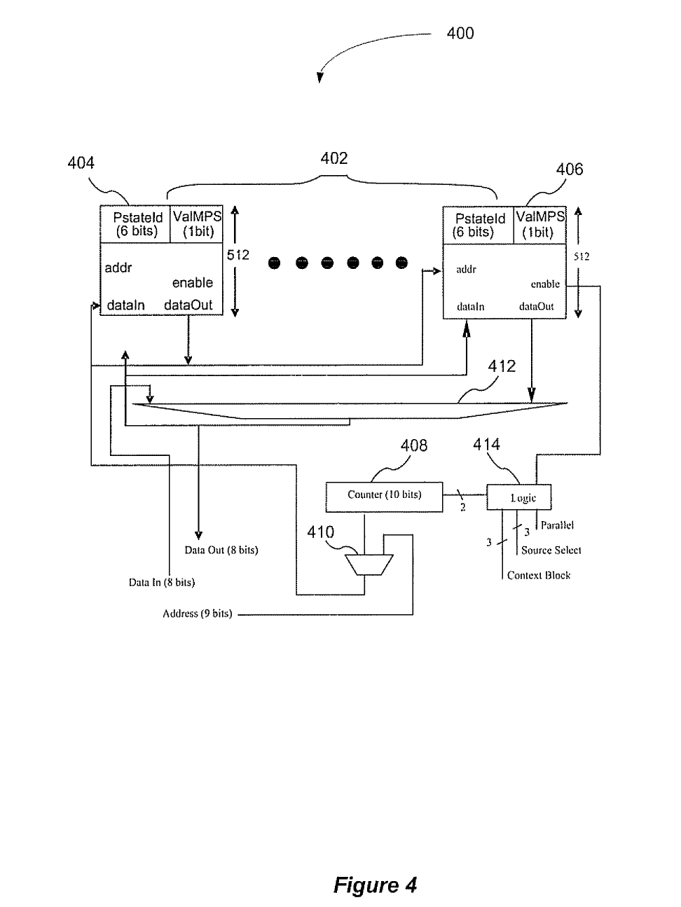

FIG. 4 illustrates a context memory management engine 400 utilizing minimum cycle time. In one embodiment, the context memory management engine 400 is part of an implementation for an Internal Store Context Management Architecture. In another embodiment, the context memory management engine has eight mode analysis states. Further, a plurality of context tables 402 may be utilized. Each context table may correspond to an analysis state. For instance, a first context table 404 may correspond to the first analysis state, and a final context table 406 may correspond to the eighth mode analysis state. The plurality of context tables 402 are initialized with the common reference context weights. In the initialization phase, the context memory engine 400 utilizes a counter 408 to generate the loading addresses. During the mode analysis phase, a switch 410 switches out the address counter with the address from the arithmetic coder. The context memory management engine 400 updates a different context table block for a different encoding mode by selecting the table output data through a switch 412. Further, the context memory management engine 400 controls the enable flags for each table through logic 414. Each one of the context tables in the plurality of context tables 402 will hold the final context state for the specific mode. At the end of the analysis phase, an external processor identifies the selected mode, which is then utilized to identify, and then replicate the block over the other context blocks. Accordingly, the context memory area for the next MB mode analysis phase is prepared.

In one embodiment, the context memory management engine 400 may utilize an additional eight 4K memory blocks and fifty three arithmetic logic modules (“ALMs”). Further, the context memory management engine 400 may utilize four hundred fifty nine additional clock cycles at the completion to broadcast the selected context table to the other blocks. Accordingly, the worst time to process an MB is: worstcase 150 MHzCycle=(modecount)*(binsPerModeMax)+(459/2)+1.

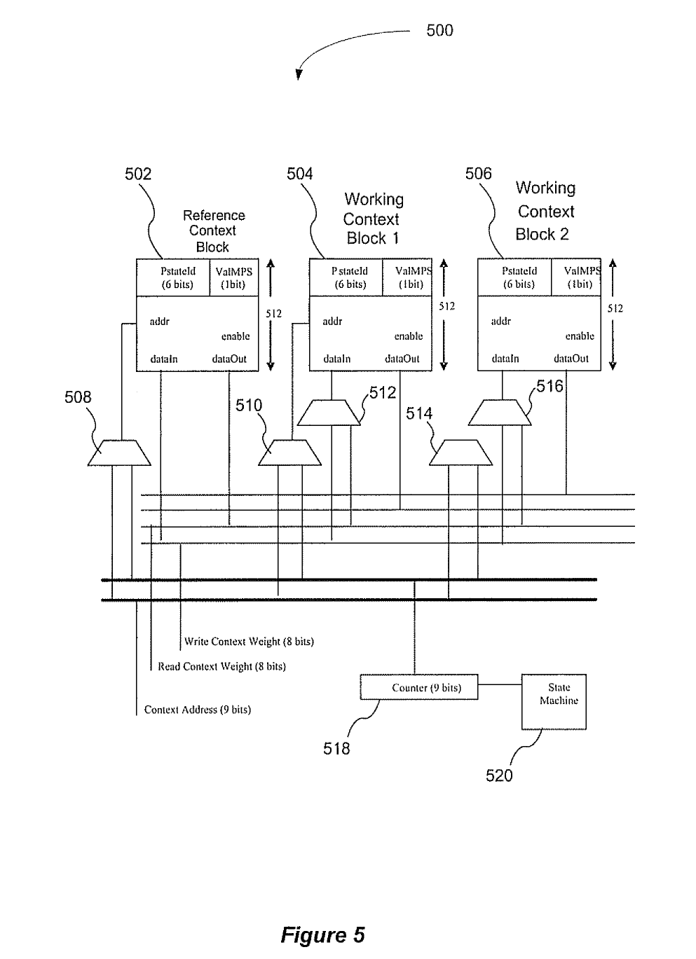

FIG. 5 illustrates an external store context management architecture 500 utilizing minimum logic hardware. In one embodiment, the external store context management architecture 500 may utilize three context memory blocks. A reference context block 502 may hold the common reference context weight values while a first working context block 504 and a second working context block 506 hold the current updated context value for the current CABAC bit count phase. A first switch 508 selects between the initialization phase address and the encoding phase address for the reference context block 502. Further, a second switch 510 selects between the initialization phase address and the encoding phase address for the working context block 504. In addition, a third switch 512 selects between the initialization phase data and the encoding phase data for the first working context block 504. A fourth switch 514 selects between the initialization phase address and the encoding phase address for the second working context block 506. Further, a fifth switch 516 selects between the initialization phase data and the encoding phase data for the second working context block 506. A counter 518, which is controlled by a state machine 520, generates the initialization addresses for the initialization phase. The first working context block 504 and the second working context block 506, i.e., the working context blocks, are updated in parallel during each of the eight CABAC bit count phases. The external store context management architecture 500 updates one of the working context blocks with the common reference context weights while updating the other working context block with the new weights based on the syntaxes form from the current CBAC bit count phase. The two working blocks are swapped in the next of the eight CABAC bit count phase. The external process is utilized to resend the syntax sequence for the selected mode back to the hardware bit counting CABAC engine to update the common reference context table to reflect the final state of the context weights after encoding the current MB. The external processor may sequentially store the syntaxes for the modes in the memory to reduce the work load. Further, the syntax sequence resend process involves a pointer adjustment and a memory data transfer between the external processor and the hardware bit counting CABAC engine of no more than one hundred sixty two sixteen bit words. In one embodiment, the one hundred sixty two sixteen bit words include a maximum of one hundred sixty two syntax per MB. In another embodiment, the minimum time per CABAC bit count phase is limited by the reference context table transfer task. In one embodiment, a maximum of four hundred fifty nine two hundred MHz clock cycles is utilized for a maximum of four hundred fifty nine context weights. In one embodiment, the external store context management architecture 500 may utilize forty eight ALMs and three M4K memory blocks. The worst case cycle time required is given by the following equation: worstCase150 MHzCycle=(modeCount+1)*(binsPerModeMax).

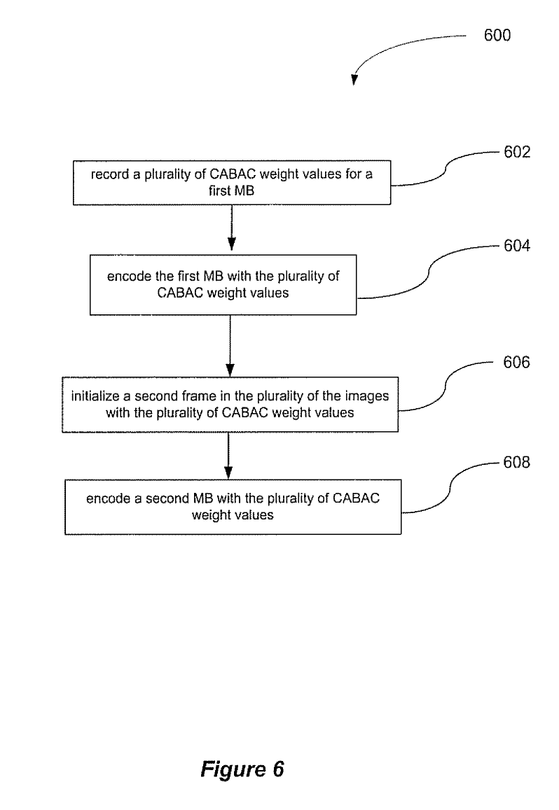

FIG. 6 illustrates a process 600 that may be utilized for encoding MBs. At a process block 602, the process 600 records a plurality of CABAC weight values for a first MB. The first MB resides in a first edge of a first frame in a plurality of images Further, at a process block 604, the process 600 encodes the first MB with the plurality of CABAC weight values. In addition, at a process block 606, the process 600 initializes a second frame in the plurality of the images with the plurality of CABAC weight values. Finally, at a process block 608, the process 600 encodes a second MB with the plurality of CABAC weight values. The second MB resides in a second edge of a second frame in the plurality of images.

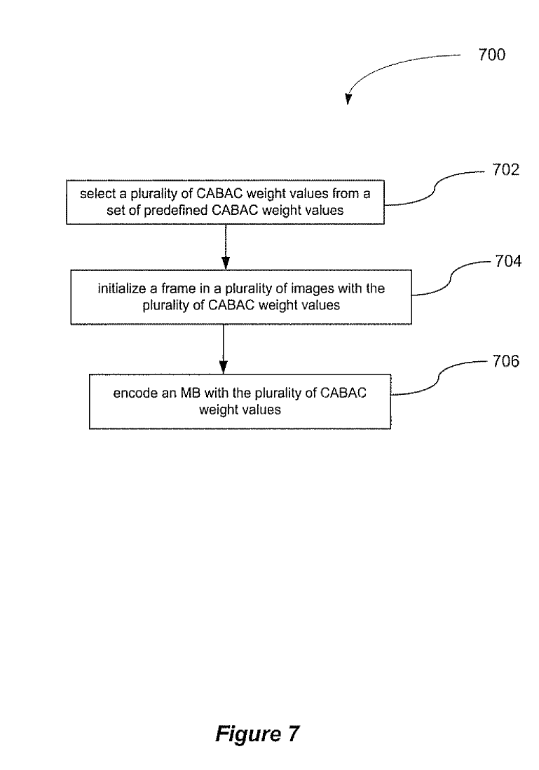

FIG. 7 illustrates another process 700 that may be utilized for encoding an MB. At a process block 702, the process 700 selects a plurality of CABAC weight values from a set of predefined CABAC weight values. Further, at a process block 704, the process 700 initializes a frame in a plurality of images with the plurality of CABAC weight values. Finally, at a process block 706, the process 700 encodes an MB with the plurality of CABAC weight values. The MB resides in an edge of the frame in the plurality of images.

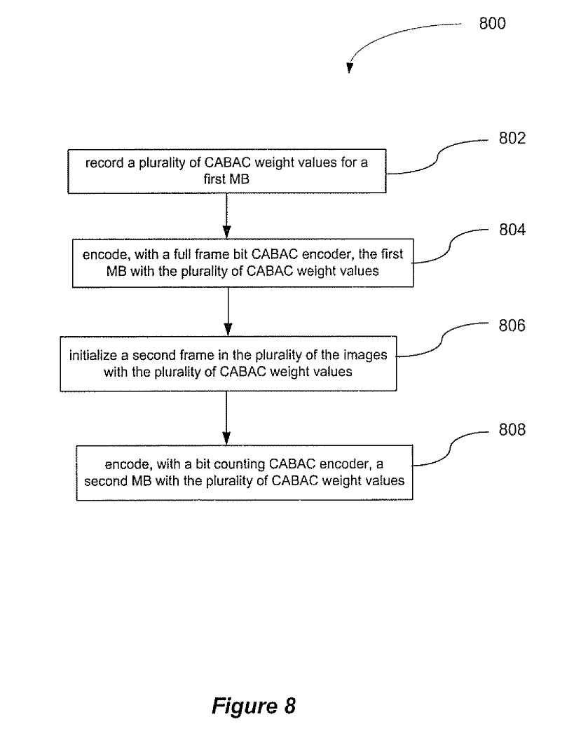

FIG. 8 illustrates yet another process 800 that may be utilized for encoding MBs. At a process block 802, the process 800 records a plurality of CABAC weight values for a first MB. The first MB resides in a first edge of a first frame in a plurality of images. Further, at a process block 804, the process 800 encodes, with a full frame bit CABAC encoder, the first MB with the plurality of CABAC weight values. In addition, at a process block 806, the process 800 initializes a second frame in the plurality of the images with the plurality of CABAC weight values. Finally, at a process block 808, the process 800 encodes, with a bit counting CABAC encoder, a second MB with the plurality of CABAC weight values. The second MB resides in a second edge of a second frame in the plurality of images.

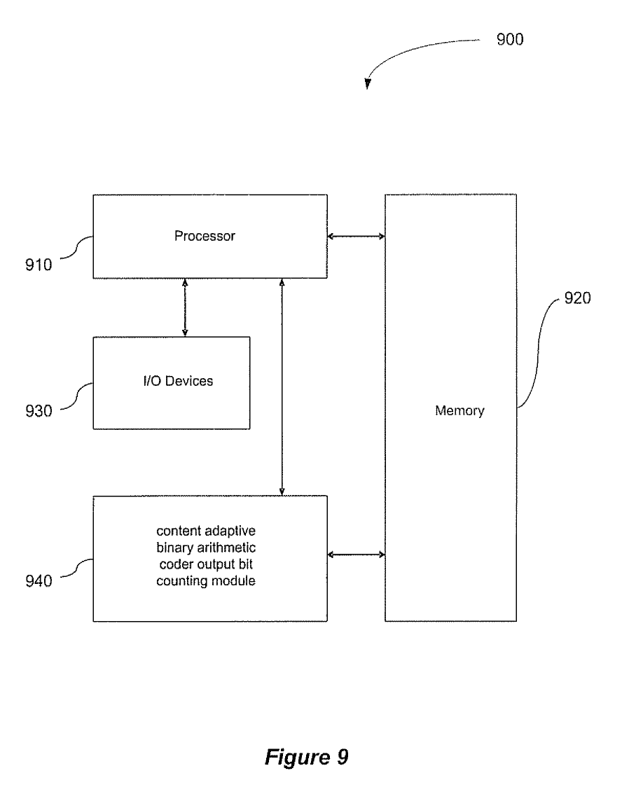

FIG. 9 illustrates a block diagram of a station or system 900 that implements content adaptive binary arithmetic coder output bit counting. In one embodiment, the station or system 900 is implemented using a general purpose computer or any other hardware equivalents. Thus, the station or system 900 comprises a processor (“CPU”) 910, a memory 920, edge, random access memory (“RAM”) and/or read only memory (ROM), a content adaptive binary arithmetic coder output bit counting module 940, and various input/output devices 930, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the content adaptive binary arithmetic coder output bit counting module 940 may be implemented as one or more physical devices that are coupled to the CPU 910 through a communication channel. Alternatively, the content adaptive binary arithmetic coder output bit counting module 940 may be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 920 of the computer. As such, the content adaptive binary arithmetic coder output bit counting module 940 (including associated data structures) of the present disclosure may be stored on a computer readable medium, e.g., RAM memory, magnetic or optical drive or diskette and the like.

It is understood that the content adaptive binary arithmetic coder output bit counting described herein may also be applied in other type of encoders. Those skilled in the art will appreciate that the various adaptations and modifications of the embodiments of this method and apparatus may be configured without departing from the scope and spirit of the present method and system. Therefore, it is to be understood that, within the scope of the appended claims, the present method and apparatus may be practiced other than as specifically described herein.

I claim:

1. A method comprising:
recording a plurality of CABAC weight values for a first macroblock, the first macroblock residing in a first edge of a first frame in a plurality of images;
encoding the first macroblock with the plurality of CABAC weight values;
initializing a second frame in the plurality of the images with the plurality of CABAC weight values; and
encoding a second macroblock with the plurality of CABAC weight values, the second macroblock residing in a second edge of a second frame in the plurality of images.

2. The method of claim 1, further comprising switching from the plurality of CABAC weight values to an additional plurality of CABAC weight values during the encoding of the second macroblock.

3. The method of claim 2, further comprising initializing the additional plurality of CABAC weight values simultaneously with the initializing of the plurality of CABAC weight values.

4. The method of claim 1, further comprising updating the plurality of CABAC weight values after the encoding of the second macroblock.

5. The method of claim 1, wherein the second frame has the same encoding type as the first frame.

6. The method of claim 1, wherein the first macroblock and the second macroblock are located in a column of the second frame.

7. The method of claim 6, wherein the first macroblock and the second macroblock are separated by a predefined distance.

8. A method comprising:
selecting a plurality of CABAC weight values from a set of predefined CABAC weight values;
initializing a frame in a plurality of images with the plurality of CABAC weight values; and
encoding a macroblock with the plurality of CABAC weight values, the macroblock residing in an edge of the frame in the plurality of images.

9. The method of claim 8, further comprising switching from the plurality of CABAC weight values to an additional plurality of CABAC weight values during the encoding of the macroblock.

10. The method of claim 9, further comprising initializing the additional plurality of CABAC weight values simultaneously with the initializing of the plurality of CABAC weight values.

11. The method of claim 8, wherein the encoding utilizes a real-time digital video encoder.

12. The method of claim 8, wherein the initializing utilizes a CABAC weight initialization engine.

13. The method of claim 8, wherein the selecting utilizes a mode selection engine.

14. A method comprising:
recording a plurality of CABAC weight values for a first macroblock, the first macroblock residing in a first edge of a first frame in a plurality of images;
encoding, with a full frame bit CABAC encoder, the first macroblock with the plurality of CABAC weight values;
initializing a second frame in the plurality of the images with the plurality of CABAC weight values; and
encoding, with a bit counting CABAC encoder, a second macroblock with the plurality of CABAC weight values, the second macroblock residing in a second edge of a second frame in the plurality of images.

15. The method of claim 14, further comprising switching from the plurality of CABAC weight values to an additional plurality of CABAC weight values during the encoding of the second macroblock.

16. The method of claim 15, further comprising initializing the additional plurality of CABAC weight values simultaneously with the initializing of the plurality of CABAC weight values.

17. The method of claim 14, further comprising updating the plurality of CABAC weight values after the encoding of the second macroblock.

18. The method of claim 14, wherein the second frame has the same encoding type as the first frame.

19. The method of claim 14, wherein the first macroblock and the second macroblock are located in a column of the second frame.

20. The method of claim 19, wherein the first macroblock and the second macroblock are separated by a predefined distance.
